(19) United States
(12) Patent Application Publication
(10) Pub. No.: US 2016/0217913 A1
(43) Pub. Date: Jul. 28, 2016

(54) WINDING UNIT, MAGNETIC COMPONENT AND POWER SUPPLY HAVING THE SAME

(71) Applicant: DELTA ELECTRONICS, INC., Taoyuan Hsien (CN)

(72) Inventors: WEI CHENG, Taoyuan Hsien (CN); Qi FU, Taoyuan Hsien (CN); Dezhi JIAO, Taoyuan Hsien (CN)

(21) Appl. No.: 14/873,929

(22) Filed: Oct. 2, 2015

(30) Foreign Application Priority Data
Jan. 26, 2015 (CN) 201510038259.X

(51) Int. Cl. H01F 27/28; H01F 27/24

(52) U.S. Cl. CPC H01F 27/288; H01F 27/24

(57) ABSTRACT

The present disclosure provides a winding unit, a magnetic component and power supply having the same. The winding unit includes: at least one winding having disposed in parallel, wherein each layer of the winding includes at least one turn of the winding, wherein at least one turn of the winding in at least one layer of the winding has a different width from at least one turn of the winding in an adjacent layer of the winding. Through the present disclosure, capacitance of parasitic capacitors of the winding unit may be effectively reduced, such that efficiency of the power supply may be improved.

### CROSS REFERENCE TO RELATED APPLICATIONS

The present application is based upon and claims priority to Chinese Patent Application No. 201510038259.X, filed on Jan. 26, 2015, the entire contents of which are incorporated herein by reference.

### TECHNICAL FIELD

The present disclosure relates to the technology field of magnetic components, and more particularly, to a winding unit, a magnetic component using the winding unit and a power supply using the magnetic component.

### BACKGROUND

With the development of smaller size, higher current and more functionality of electronic devices, the power supply also tends to be more miniaturized and has higher power densities. In order to meet the above requirement of the power supply, magnetic components with higher operating frequencies and smaller volumes are more widely used in various applications.

For a high-frequency power supply, a turn-on loss of a switch Sw is a considerable part of the whole loss of the power supply. The equivalent capacitance Ceq which across the switching component Sw is an important factor of the turn-on loss. The capacitance value of C_{eq} is related to components coupled with the switch of the power supply, such as magnetic components. Accordingly, there is a need to reduce the parasitic capacitance of the winding units, so as to reduce the equivalent capacitance C_{eq}, and in turn, to reduce the turn-on loss and improve efficiency of the power supply.

### SUMMARY

An object of the present disclosure is to provide a winding unit, a magnetic component using the winding unit and a power supply using the magnetic component, in which parasitic capacitance of the winding unit may be reduced.

Other features and advantages of the present disclosure will become apparent from the following detailed description, or partly learned from practice of the present disclosure.

According to a first aspect of the present disclosure, a winding unit is provided. The winding unit includes: at least one winding, having a plurality of layers disposed in parallel, wherein each layer of the winding comprises at least one turn of the winding, wherein at least one turn of the winding in at least one layer of the winding has a different width from at least one turn of the winding in an adjacent layer of the winding.

According to a second aspect of the present disclosure, a magnetic component is provided. The magnetic component includes: at least one winding unit, including: at least one winding, having a plurality of layers disposed in parallel, wherein each layer of the winding comprises at least one turn of the winding, wherein at least one turn of the winding in at least one layer of the winding has a different width from at least one turn of the winding in an adjacent layer of the winding.

According to a third aspect of the present disclosure, a power supply is provided. The power supply includes the winding unit according to any one of the above embodiments.

### BRIEF DESCRIPTION OF THE DRAWINGS

The above and other features and advantages of the present disclosure will become more apparent from the detailed description of the exemplary embodiments with reference to accompanying drawings.

FIG. 1 is a schematic structural diagram of a magnetic component in the prior art;

FIG. 2 is a schematic diagram of a winding unit in an exemplary embodiment of the present disclosure;

FIG. 3 is a schematic diagram of another winding unit in an exemplary embodiment of the present disclosure;

FIG. 4 is a schematic diagram of another winding unit in an exemplary embodiment of the present disclosure;

FIG. 5 is a schematic structural diagram of another magnetic component in the prior art;

FIG. 6 is a schematic diagram of another winding unit in an exemplary embodiment of the present disclosure;

FIG. 7 is a schematic diagram of another winding unit in an exemplary embodiment of the present disclosure;

FIG. 8 is a schematic diagram of another winding unit in an exemplary embodiment of the present disclosure;

FIG. 9 is a schematic circuit diagram of a typical fly-back converter; and

FIG. 10 is a schematic circuit diagram of a typical boost converter.

### DETAILED DESCRIPTION

Hereinafter, the exemplary embodiments are fully described with reference to the accompany drawings. However, the exemplary embodiments may be implemented in various forms, and should not be construed as limited to the embodiments set forth herein. Rather, these embodiments are provided to make the present disclosure more complete and thorough, and to fully convey the concept of the exemplary embodiments to those skilled in the art. In the accompany drawings, thicknesses of regions and layers are exaggerated for clarity. Same reference numbers refer to the same or similar structure throughout the accompany drawings, and detailed description thereof may be omitted.

In addition, the described features, structures and characteristics may be combined to one or more embodiments in any proper manner. In the description below, many specific details are provided for a thorough understanding of the embodiments of the present disclosure. However, it will be appreciated by those skilled in the art that, the technical solutions of the present disclosure may be practiced without one or more of the particular details, or may use other method, devices or connections, etc. In other circumstances, known structures, methods or operations will not be illustrated in detail so as to avoid obscuring the aspects of the present disclosure.

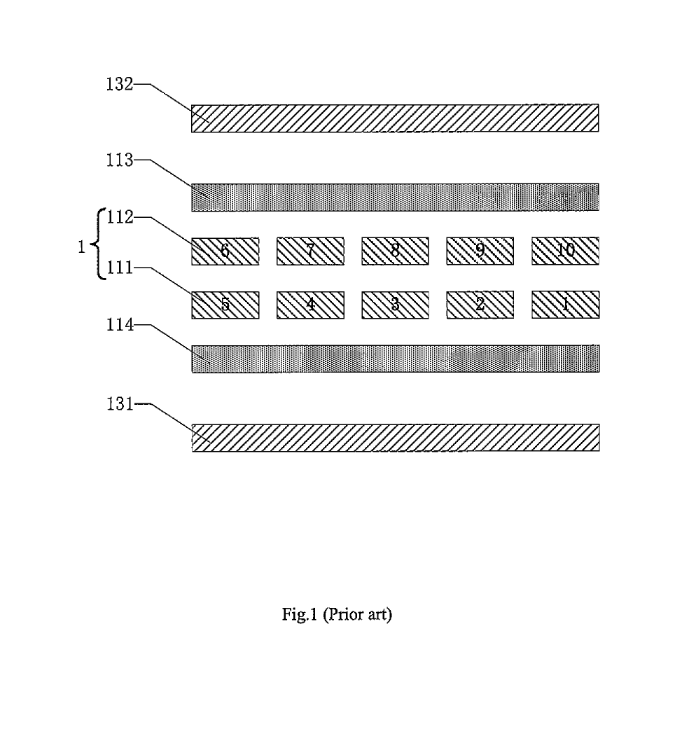

As shown in FIG. 1, in two layers of the winding 111 and 112 of a winding unit 1 of a magnetic component in the prior art, respective turns of the winding substantially have the same width, and the corresponding turns of the winding in the two layers of the winding face exactly to each other. By such conventional layout design, parasitic capacitance of the winding unit is relatively large due to a relatively large facing area between the layers of the winding, which may lead to a relatively large turn-on loss in the switching component operating in a high frequency, thus efficiency of the power supply is decreased.

Accordingly, in the exemplary embodiments of the present disclosure, a winding unit is provided firstly. The winding unit includes at least one winding having a plurality of layers disposed in parallel, and each of the layers of the winding includes at least one turn of the winding. Wherein at least one turn of the winding in at least one layer of the winding has a different width from at least one turn of the winding in an adjacent layer of the winding. Thereby, parasitic capacitance may be reduced by reducing a facing area between the layers of the winding. Examples are given as follows.

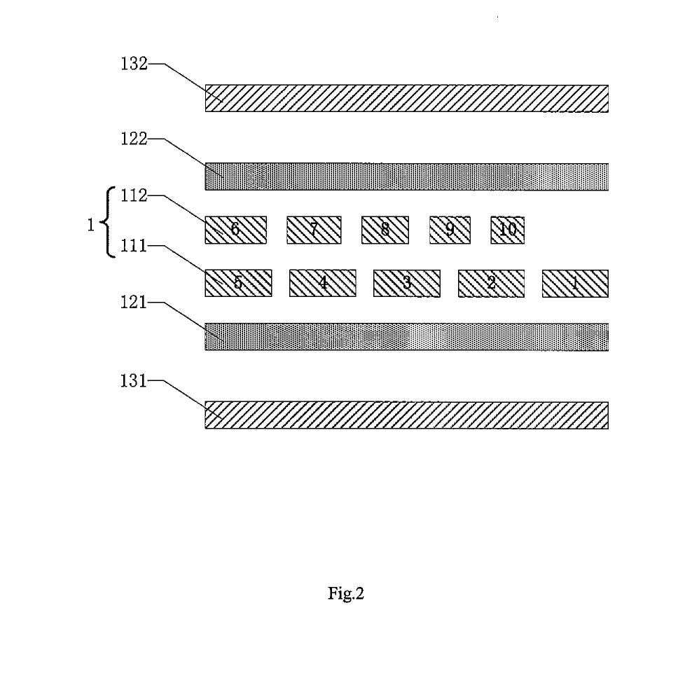

As shown in FIG. 2, the winding unit 1 includes a first layer of the winding 111 and a second layer of the winding 112 disposed face to face. Each of the first layer of the winding 111 and the second layer of the winding 112 includes at least one turn of the winding. For example, in the exemplary embodiment, the winding may include N turns of the winding (for example, 10 turns of the winding) connected sequentially. The turns of the winding are respectively layout-designed in the first layer of the winding 111 and the second layer of the winding 112. However, in other exemplary embodiments of the present disclosure, the winding unit may also include more layers of the winding, which is not limited to the present exemplary embodiment.

In the present exemplary embodiment, at least one turn of the winding in the second layer of the winding 112 has a different width from at least one turn of the winding in the first layer of the winding 111. For example, at least a part of a projection of at least one turn of the winding in the second layer of the winding 112 falls beyond the turns of the winding in the first layer of the winding 111. That is, the turns of the winding in the first layer of the winding 111 and the turns of the winding in the second layer of the winding 112 are not exactly overlapped face to face. Otherwise, a projection of the at least one turn of the winding in the second layer of the winding 112 falls within a corresponding turn of the winding in the first layer of the winding 111, and the width of the at least one turn of the winding in the second layer of the winding 112 is less than that of the corresponding turn of the winding in the first layer of the winding 111, so as to reduce the facing area between the first layer of the winding 111 and the second layer of the winding 112, and in turn to reduce parasitic capacitance between the first layer of the winding 111 and the second layer of the winding 112. Further description thereof is given as follows.

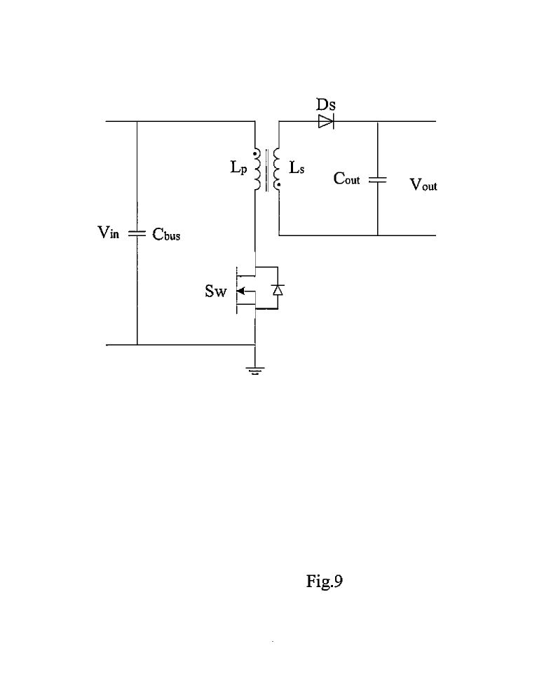

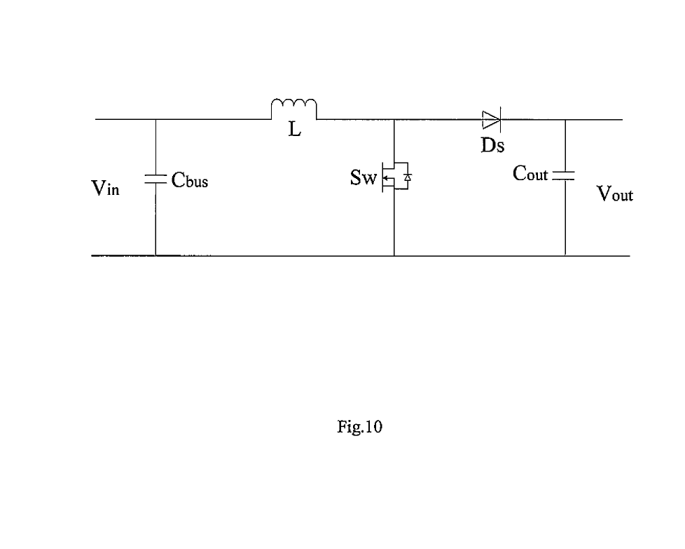

For example, as shown in FIG. 2, the first layer of the winding 111 may include a first turn of the winding to a fifth turn of the winding, and the second layer of the winding 112 may include a sixth turn of the winding to a tenth turn of the winding. The first turn of the winding may be used for coupling to a bus capacitor (such as C_{bus} shown in FIG. 9 or 10). The tenth turn of the winding may be used for coupling to a switch (such as Sw shown in FIG. 9 or 10). In the first layer of the winding 111, each turn of the winding has the same width. In the second layer of the winding 112, each turn of the winding has a width less than that of each turn of the winding in the first layer of the winding 111. Moreover, for example, a projection of the sixth turn of the winding falls within the corresponding fifth turn of the winding, and a part of a projection of the eighth turn of the winding falls beyond the facing third turn of the winding. Compared with FIG. 1, in FIG. 2, the width of each turn of the winding in the second layer of the winding 112 is adjusted, such that the facing area between the first layer of the winding 111 and the second layer of the winding 112 is reduced, thus the parasitic capacitance between the first layer of the winding 111 and the second layer of the winding 112 may be reduced.

Further, in the second layer of the winding 112, each turn of the winding may have a different width or the same width, or a part of the turns of the winding may have the same width and a part of them may have different widths. It may be sufficient as long as at least one turn of the winding in the second layer of the winding 112 has a different width from that in the first layer of the winding 111, such that the facing area between the first layer of the winding 111 and the second layer of the winding 112 is reduced, so as to reduce the parasitic capacitance between the first layer of the winding 111 and the second layer of the winding 112.

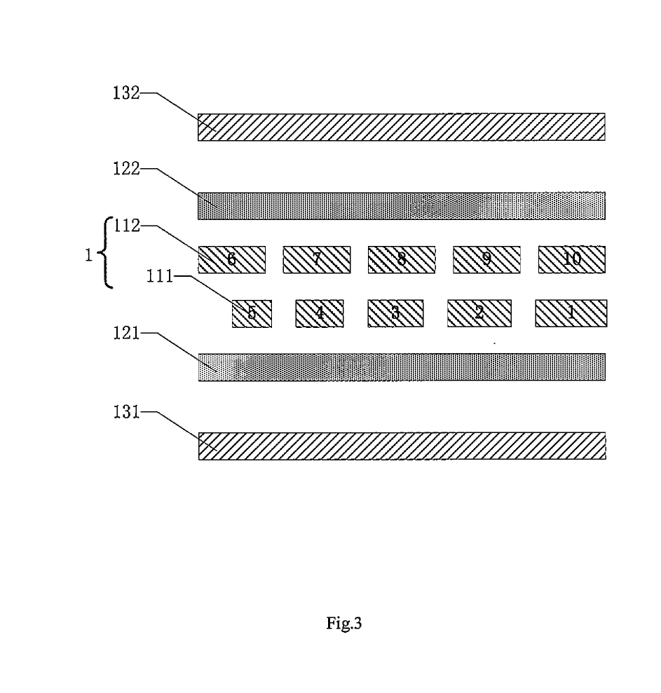

For another example, as shown in FIG. 3, the first layer of the winding 111 may include a first turn of the winding to a fifth turn of the winding, and the second layer of the winding 112 may include a sixth turn of the winding to a tenth turn of the winding. The first turn of the winding may be used for coupling to a bus capacitor (such as C_{bus} shown in FIG. 9 or 10). The tenth turn of the winding may be used for coupling to a switch (such as Sw shown in FIG. 9 or 10). In the second layer of the winding 112, each turn of the winding has the same width. In the first layer of the winding 111, each turn of the winding has a width less than that of each turn of the winding in the second layer of the winding 112. Compared with FIG. 1, in FIG. 3, the width of each turn of the winding in the first layer of the winding 111 is adjusted, such that the facing area between the first layer of the winding 111 and the second layer of the winding 112 is reduced, thus the parasitic capacitance between the first layer of the winding 111 and the second layer of the winding 112 may be reduced.

Further, in the first layer of the winding 111, each turn of the winding may have a different width or the same width, or a part of the turns of the winding may have the same width and a part of them may have different widths.

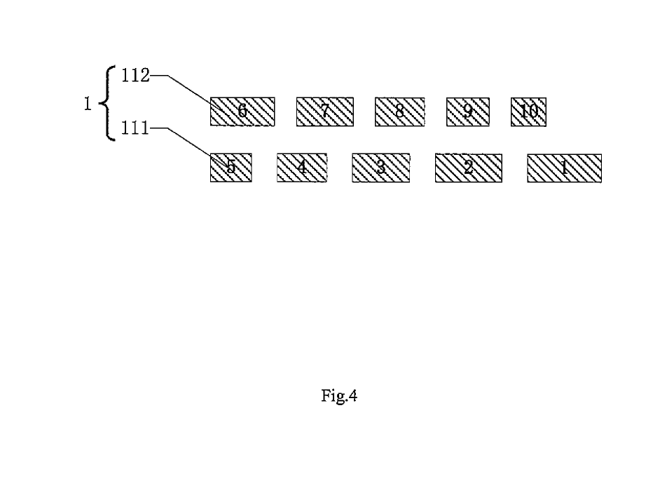

For still another example, as shown in FIG. 4, the first layer of the winding 111 may include a first turn of the winding to a fifth turn of the winding, and the second layer of the winding 112 may include a sixth turn of the winding to a tenth turn of the winding. The first turn of the winding may be used for coupling to a bus capacitor (such as C_{bus} shown in FIG. 9 or 10). The tenth turn of the winding may be used for coupling to a switch (such as Sw shown in FIG. 9 or 10). In the first layer of the winding 111, parts of the turns of the winding have widths less than widths of parts of the turns of the winding in the second layer of the winding 112, and parts of the turns of the winding have widths greater than widths of parts of the turns of the winding in the second layer of the winding 112. Correspondingly, in the second layer of the winding 112, parts of the turns of the winding have widths less than widths of parts of the turns of the winding in the first layer of the winding 111, and parts of the turns of the winding have widths greater than widths of parts of the turns of the winding in the first layer of the winding 111. Compared with FIG. 1, in FIG. 4, the width of each turn of the winding in the first layer of the winding 111 and each turn of the winding in the second layer of the winding 112 is adjusted, such that the facing area between the first layer of the winding 111 and the second layer of the winding 112 is reduced, thus the parasitic capacitance between the first layer of the winding 111 and the second layer of the winding 112 may be reduced.

It should be noted that, in an embodiment of the present disclosure, the number of turns of the winding which have reduced widths may be chosen according to practical need. For example, one of the turns of the winding in one of the layers of the winding may have a width less than that of a turn of the winding in its adjacent layer, which may achieve an object of reducing parasitic capacitance. In addition, according to the voltage distribution of respective turns of the winding, turns of the winding which have higher distribution voltages may be firstly selected to reduce width. For example, in FIG. 2, the widths of the turns of the winding in the second layer of the winding 112 are decreased gradually from the sixth turn of the winding to the tenth turn of the winding. In FIG. 3, the widths of the turns of the winding in the first layer of the winding 111 are decreased gradually from the first turn of the winding to the fifth turn of the winding. In FIG. 4, the widths of the turns of the winding in the first layer of the winding 111 are decreased gradually from the first turn of the winding to the fifth turn of the winding, and the widths of the turns of the winding in the second layer of the winding 112 are decreased gradually from the sixth turn of the winding to the tenth turn of the winding. Thereby, the parasitic capacitance between the first layer of the winding 111 and the second layer of the winding 112 may be further reduced. While the widths of the related turns of the winding are adjusted, the effect on the impedance of the turns of the winding and safety distances between adjacent turns of the winding should be considered and ensured. In addition, the first layer of the winding 111 and the second layer of the winding 112 may include more or less turns of the winding, which is not limited to the above embodiment.

In the present exemplary embodiment, a magnetic component including the above winding unit 1 is also provided. FIGS. 2 and 4 show a transformer including at least one of the above winding unit 1, wherein at least one winding of the above winding unit 1 is disposed at a primary side of the magnetic component, as a primary winding of the transformer. The transformer also includes at least secondary winding 131 and 132, disposed at a secondary side of the magnetic component. In an exemplary embodiment of the present disclosure, the transformer may further include a shielding layer 121 and a shielding layer 122, respectively disposed between the primary winding and the secondary winding 131 and 132. FIG. 4 shows an inductor including at least one of the above winding unit 1. The winding unit 1 includes at least one winding having a plurality of layers disposed in parallel, and each layer of the winding includes at least one turn of the winding. Wherein at least one turn of the winding in at least one layer of the winding has a different width from at least one turn of the winding in an adjacent layer of the winding. For example, the winding unit may include a first layer of the winding 111 including at least one turn of the winding and a second layer of the winding 112 including at least one turn of the winding, and the first layer of the winding 111 and the second layer of the winding 112 are disposed face to face. Wherein at least one turn of the winding in the first layer of the winding 111 has a different width from at least one turn of the winding in the second layer of the winding 112, such that in an exemplary embodiment of the present disclosure, at least a part of a projection of the at least one turn of the winding in the first layer of the winding 111 falls beyond the turns of the winding in the second layer of the winding 112. Otherwise, a projection of the at least one turn of the winding in the first layer of the winding 111 falls within a corresponding turn of the winding in the second layer of the winding 112. In an embodiment of the present disclosure, the above transformer is a planar transformer. For example, the winding unit of the above transformer may be printed in a PCB (Printed Circuit Board). In an embodiment of the present disclosure, the winding unit of the above inductor may be printed in a PCB.

In an exemplary embodiment of the present disclosure, the winding unit includes N turns of the winding connected sequentially. The first layer of the winding 111 includes a first turn of the winding to an N/2^{th} turn of the winding, and the first turn of the winding may be used for coupling to a bus capacitor. The second layer of the winding 112 includes an (N/2+1)^{th} turn of the winding to an N^{th} turn of the winding, and the N^{th} turn of the winding may be used for coupling to a switch. Otherwise, the first layer of the winding 111 includes an (N/2+1)^{th} turn of the winding to an N^{th} turn of the winding, and the N^{th} turn of the winding may be used for coupling to a switching component; and the second layer of the winding 112 includes a first turn of the winding to an N/2^{th} turn of the winding, and the first turn of the winding may be used for coupling to a bus capacitor.

For the above magnetic component, specific embodiments have been described in detail in the exemplary embodiments of the winding unit, and will not be repeated herein.

For the plurality of layers of the winding, the larger the voltage differences between corresponding turns of the winding in the layers of the winding are, the larger the capacitance of parasitic capacitors between the layers of the winding will be. Accordingly, the total capacitance of parasitic capacitors between the layers of the winding may also be effectively reduced by reducing the relative voltage differences between facing turns of the winding in the layers of the wingding. Accordingly, as shown in FIG. 2, while the widths of the turns of the winding in the second layer of the winding 112 are reduced, it may be considered to move them toward a position of a turn of the winding having a low distribution voltage, that is, move them toward the position of the sixth turn of the winding. Since the voltage differences between the sixth turn of the winding and the turns of the winding in the first layer of the winding 111 are relatively small, by moving toward the position of the sixth turn of the winding, the relative voltage differences between corresponding turns of the winding in the layers of the winding may be reduced, thus the capacitance of parasitic capacitors between the layers of the winding may be effectively reduced. As shown in FIG. 4, the turns of the winding in the first layer of the winding 111 are moved toward a position of a winding having a high distribution voltage, that is, moved toward the position of the fifth turn of the winding, and the turns of the winding in the second layer of the winding 112 are moved toward a position of a winding having a low distribution voltage, that is, moved toward the position of the sixth turn of the winding. Meanwhile, as shown in FIG. 3, the turns of the winding in the first layer of the winding 111 may be moved toward the position of the fifth turn of the winding. Thereby, the voltage differences between corresponding turns of the winding in each layer of the winding may be reduced, such that the capacitance of parasitic capacitors in the winding unit may be further reduced. In addition, in an exemplary embodiment, relative voltage differences between corresponding turns of the winding in adjacent layers of the winding are distributed according to a preset rule, such that the capacitance of parasitic capacitors between each layer of the winding is small. The further description is given as follows.

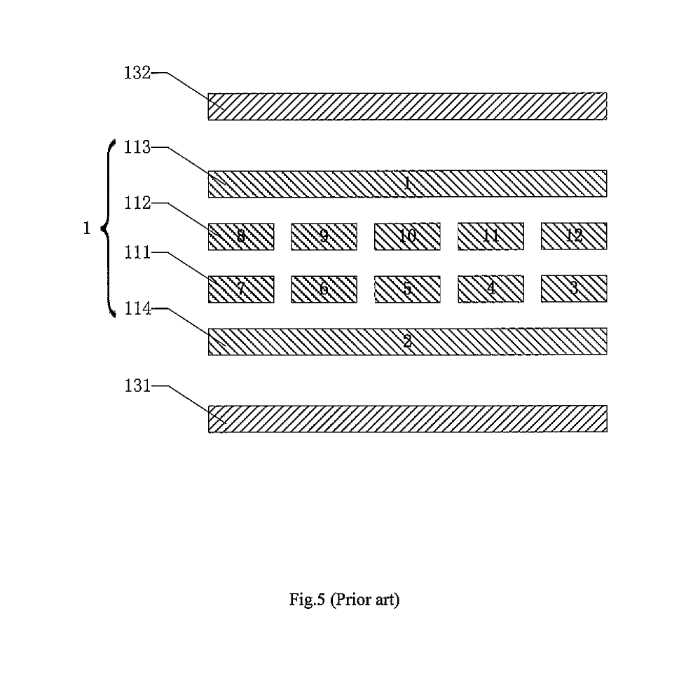

As shown in FIG. 5, the winding unit includes a first turn of the winding to an N^{th} (N is shown as 12) turn of the winding. Wherein the first turn of the winding may be used for coupling to a bus capacitor (such as C_{bus} shown in FIG. 9 or 10). The twelfth turn of the winding may be used for coupling to a switch (such as Sw shown in FIG. 9 or 10). Since the voltage of the bus capacitor may be considered as stable, in practical application, the first turn and the second turn of the winding unit coupled with the bus capacitor, namely a third layer of the winding 113 and a fourth layer of the winding 114 shown in the drawing, may serve as shielding layers. The turns of the winding adjacent to the switching component at the primary side have relatively high distribution voltages. For example, as shown in the drawing, the twelfth turn of the winding is directly coupled with the switching component at the primary side, so it has the highest distribution voltage. The distribution voltages of the turns of the winding are gradually reduced from the twelfth turn of the winding to the first turn of the winding. FIG. 5 shows an layout design of layers of the winding in the prior art, in which the third turn of the winding to the seventh turn of the winding are layout-designed in the first layer of the winding 111, the eighth turn of the winding to the twelfth turn of the winding are layout-designed in the second layer of the winding 112, the first layer of the winding 111 is adjacent to the fourth layer of the winding 114, and the second layer of the winding 112 is adjacent to the third layer of the winding. Since the second layer of the winding 112 has the highest distribution voltage, and the third layer of the winding 113 has the lowest distribution voltage, the voltage difference between the second layer of the winding 112 and the third layer of the winding 113 is relatively large, thus the capacitance of parasitic capacitors between the layers of the winding are relatively large.

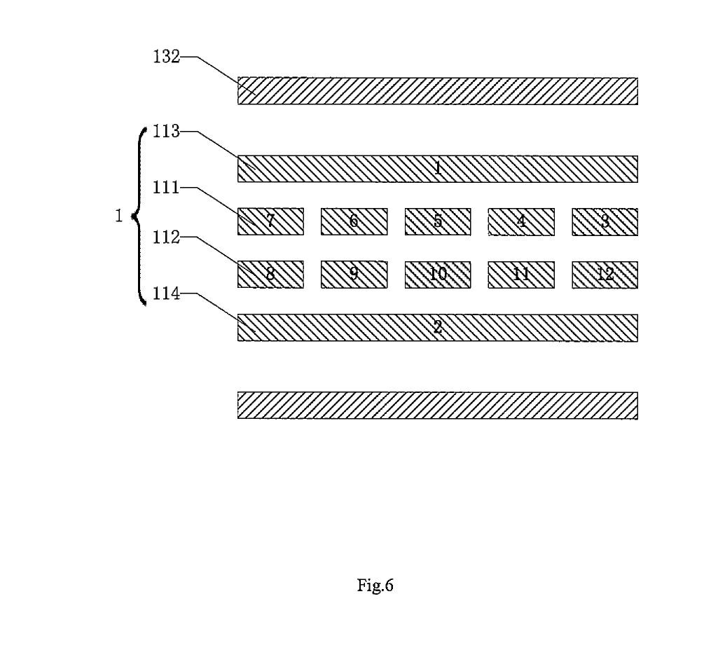

As shown in FIG. 6, in the present embodiment of the present disclosure, the position of the first layer of the winding 111 and the position of the second layer of the winding 112 are swapped with respect to those shown in FIG. 5. That is, the first layer of the winding 111 is adjacent to the third layer of the winding 113, and the second layer of the winding 112 is adjacent to the fourth layer of the winding 114. This layout design reduces the relative voltage differences between the layers of the winding, thus the capacitance of parasitic capacitors of the winding unit may be reduced.

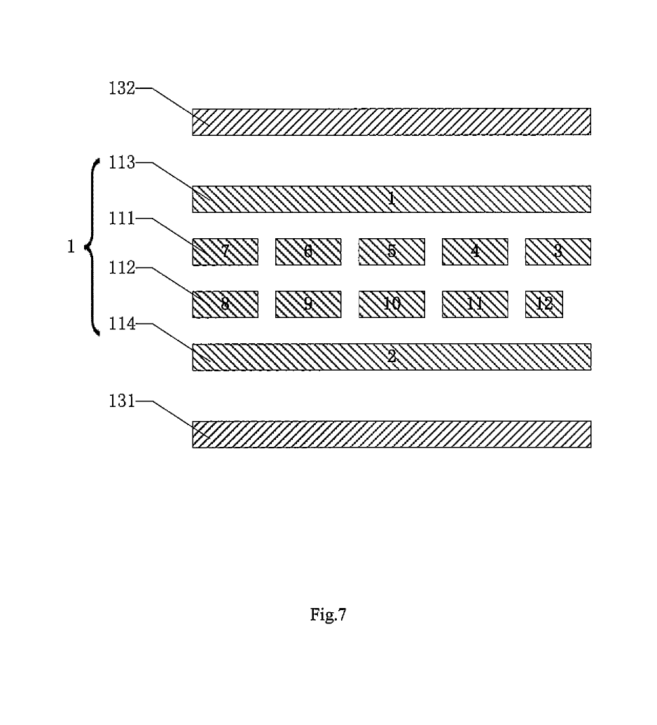

In a preferred exemplary embodiment, in addition to reducing facing area between the layers of the winding in the above exemplary embodiments, the layout design of turns of the winding is optimized as shown in FIG. 6. That is, as shown in FIG. 7, the layout design of turns of the winding is optimized, and the facing area between the layers of the winding is also reduced. Further, in another embodiment, as shown in FIG. 7, since the twelfth turn of the winding has the highest distribution voltage, and the second turn of the winding and the third turn of the winding face to the twelfth turn of the winding, the relative voltage differences respectively between the twelfth turn of the winding and the second turn of the winding and between the twelfth turn of the winding and the third turn of the winding are relatively high. If the width of the twelfth turn of the winding is reduced, the parasitic capacitance of the winding unit may be effectively reduced. If effect on the impedance of the turns of the winding is not large, the width of each of the turns of the winding may be adjusted, so as to reduce the parasitic capacitance of the winding unit.

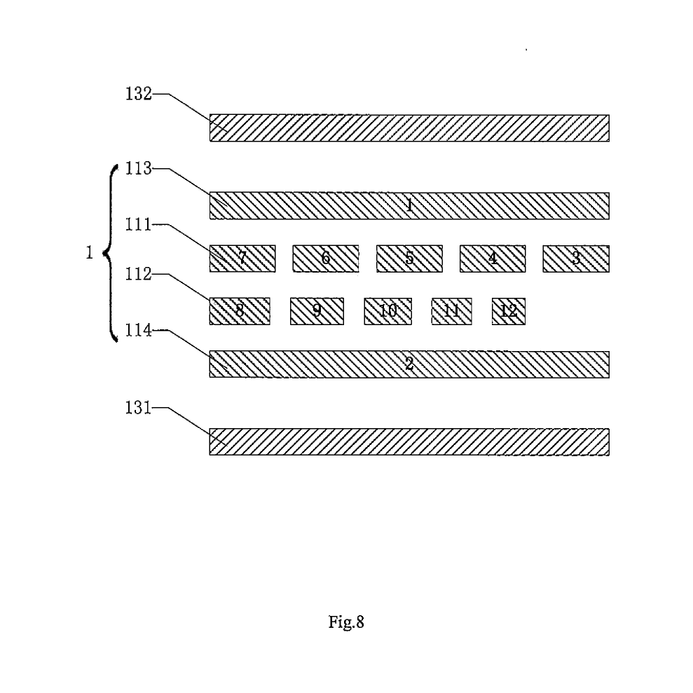

In addition, while the safety distance may be ensured, the layout-designed position of each turn of the winding in the second layer of the winding 112 may be adjusted to be biased toward a position of a turn of the winding having a lower distribution voltage in the second layer of the winding 112. Otherwise, the layout-designed position of each turn of the winding in the first layer of the winding 111 may be adjusted to be biased toward a position of a turn of the winding having a higher distribution voltage in the first layer of the winding 111. That is, the turns of the winding in each layer of the winding may be adjusted toward a direction that may reduce the voltage differences between the layers of the winding. For example, as shown in FIG. 8, in addition to reducing the facing areas between the layers of the winding of the winding unit 1, the relative voltage differences between the layers of the winding may also be reduced, so as to reduce the capacitance of parasitic capacitors of the winding unit. Experiments indicate that, the total capacitance of parasitic capacitors of the winding unit shown in FIG. 8 may be reduced by at least 3 times than the total capacitance of parasitic capacitors of the winding unit shown in FIG. 5.

In the above exemplary embodiments, the third turn of the winding to the N^{th} turn of the winding may be wound in a C form. In other exemplary embodiments, they may be wound in a Z form, a progressive form, a segmented form, and so on, which may also reduce the capacitance of parasitic capacitors of the winding unit.

Further, in the exemplary embodiments, a transformer including the above winding unit 1 is also provided. As shown in FIGS. 6 to 8, the transformer includes at least one winding of the winding unit 1, located at the primary side of the magnetic component, as the primary winding of the transformer; and at least one secondary winding, located at the secondary side of the magnetic component. The winding unit 1 includes a plurality layers of the winding disposed in parallel, for example, the winding unit 1 includes the first layer of the winding to the fourth layer of the winding. Each layer of the winding includes at least one turn of the winding. Wherein at least one turn of the winding in at least one layer of the winding has a different width from at least one turn of the winding in an adjacent layer of the winding. For example, the turns of the winding include N turns of the winding connected sequentially. The first turn of the winding may be used for coupling with a bus capacitor and is included in the third layer of the winding 113. The second turn of the winding is included in the fourth layer 114 of the winding. The first layer of the winding 111 includes the third turn of the winding to the (N/2+1)^{th} turn of the winding. The second layer of the winding 112 includes the (N/2+2)^{th} turn of the winding to the N^{th} turn of the winding. The N^{th} turn of the winding may be used for coupling with a switch. The third layer of the winding 113 and the fourth layer of the winding 114 respectively serve as the shielding layers between the primary winding and the secondary winding 131 and 132. Relative voltage differences between corresponding turns of the winding in adjacent layers of the winding are distributed according to a preset rule. For example, in an exemplary embodiment of the present disclosure, the first layer of the winding 111 and the second layer of the winding 112 are disposed between the third layer of the winding 113 and the fourth layer of the winding 114, the first layer of the winding 111 is adjacent to the third layer of the winding 113, and the second layer of the winding 112 is adjacent to the fourth layer of the winding 114. For further example, in another exemplary embodiment of the present disclosure, the layout-designed position of each turn of the winding in the second layer of the winding 112 may be adjusted to be biased toward a position of a turn of the winding having a lower distribution voltage, and so on.

In an embodiment of the present disclosure, the above winding unit 1 may also be applied to an inductor winding. That is, in addition to reducing the facing area between the layers of the winding, the relative voltage differences between the layers of the winding are also reduced, thus the capacitance of parasitic capacitors of the winding unit may be effectively reduced.

For the above magnetic component, the specific embodiments have been described in detail in the exemplary embodiments of the winding unit, and will not be repeated herein.

In the exemplary embodiments, a power supply is also provided. The power supply includes any one of the above described winding unit or magnetic component. For example, the power supply may be a fly-back transformer shown in FIG. 9, or other isolation transformer. Since parasitic capacitance of the winding unit applied in the transformer of the power supply is effectively reduced, efficiency of the power supply may be further improved. For further example, the power supply may be a boost transformer shown in FIG. 10 or other converter. Since parasitic capacitance of the winding unit applied in the inductor of the power supply is effectively reduced, efficiency of the power supply may be further improved.

Accordingly, in the exemplary embodiments of the present disclosure, the facing areas between layers of the winding are reduced, and further, layout design of the turns of the winding in the layers of the winding are optimized, such that the voltage differences between layers of the winding are reduced. Consequently, the capacitance of parasitic capacitors of the winding unit may be effectively reduced, such that the efficiency of the power supply is improved.

Although the present disclosure has been described with reference to above embodiments, the above described embodiments are merely examples for implementing the present disclosure. It should be noted that, the disclosed embodiments are not intended to limit the scope of the present disclosure. Rather, alteration and modification without departing from the spirit and scope of the present disclosure all fall in the protective scope of the present disclosure.

What is claimed is:

1. A winding unit, comprising:
at least one winding, having a plurality of layers disposed in parallel, wherein each layer of the winding comprises at least one turn of the winding,
wherein at least one turn of the winding in at least one layer of the winding has a different width from at least one turn of the winding in an adjacent layer of the winding.

2. The winding unit according to claim 1, wherein the winding comprises:
a first layer of the winding, comprising at least one turn of the winding; and
a second layer of the winding, comprising at least one turn of the winding, wherein the first layer of the winding and the second layer of the winding are disposed face to face,
wherein at least one turn of the winding in the first layer of the winding has a different width from at least one turn of the winding in the second layer of the winding.

3. The winding unit according to claim 2, wherein at least a part of a projection of at least one turn of the winding in the first layer of the winding falls beyond the turns of the winding in the second layer of the winding.

4. The winding unit according to claim 2, wherein a projection of at least one turn of the winding in the first layer of the winding falls within a corresponding turn of the winding in the second layer of the winding, and the width of the at least one turn of the winding in the first layer of the winding is less than that of the corresponding turn of the winding in the second layer of the winding.

5. The winding unit according to claim 2, wherein the turns of the winding comprises N turns of the winding connected sequentially,
a first turn of the winding is for coupling with a bus capacitor, and is contained in a third layer of the winding,
a second turn of the winding is contained in a fourth layer of the winding,
a third turn of the winding to an (N/2+1)^{th} turn of the winding are contained in the first layer of the winding, and
an (N/2+2)^{th} turn of the winding to an N^{th} turn of the winding are contained in the second layer of the winding, and the N^{th} turn of the winding is for coupling with a switch.

6. The winding unit according to claim 5, wherein the first layer of the winding and the second layer of the winding are located between the third layer of the winding and the fourth layer of the winding, the first layer of the winding is adjacent to the third layer of the winding, and the second layer of the winding is adjacent to the fourth layer of the winding.

7. The winding unit according to claim 2, wherein layout-designed positions of the turns of the winding in the plurality of layers of the winding are biased toward a position of a turn of the winding having a lowest distribution voltage difference between the plurality of layers of the winding.

8. The winding unit according to claim 7, wherein the layout-designed positions of the turns of the winding in the first layer of the winding are biased toward a position of a turn of the winding having a highest distribution voltage in the first layer of the winding.

9. The winding unit according to claim 7, wherein the layout-designed positions of the turns of the winding in the second layer of the winding are biased toward a position of a turn of the winding having a lowest distribution voltage in the second layer of the winding.

10. The winding unit according to claim 7, wherein the layout-designed positions of the turns of the winding in the first layer of the winding are biased toward a position of a turn of the winding having a highest distribution voltage in the first layer of the winding, and the layout-designed positions of the turns of the winding in the second layer of the winding are biased toward a position of a turn of the winding having a lowest distribution voltage in the second layer of the winding.

11. A magnetic component, comprising:
at least one winding unit, comprising:
at least one winding, having a plurality of layers disposed in parallel, wherein each layer of the winding comprises at least one turn of the winding,
wherein at least one turn of the winding in at least one layer of the winding has a different width from at least one turn of the winding in an adjacent layer of the winding.

12. The magnetic component according to claim 11, wherein the winding comprises:
a first layer of the winding, comprising at least one turn of the winding; and
a second layer of the winding, comprising at least one turn of the winding, wherein the first layer of the winding and the second layer of the winding are disposed face to face,
wherein at least one turn of the winding in the first layer of the winding has a different width from at least one turn of the winding in the second layer of the winding.

13. The magnetic component according to claim 12, wherein at least a part of a projection of at least one turn of the winding in the first layer of the winding falls beyond the turns of the winding in the second layer of the winding.

14. The magnetic component according to claim 12, wherein a projection of the at least one turn of the winding in the first layer of the winding falls within a corresponding turn of the winding in the second layer of the winding, and the width of the at least one turn of the winding in the first layer of the winding is less than that of the corresponding turn of the winding in the second layer of the winding.

15. The magnetic component according to claim 12, wherein
the turns of the winding comprises N turns of the winding connected sequentially,
a first turn of the winding is for coupling with a bus capacitor, and is contained in a third layer of the winding,
a second turn of the winding is contained in a fourth layer of the winding,
a third turn of the winding to an (N/2+1)^{th} turn of the winding are contained in the first layer of the winding, and
an (N/2+2)^{th} turn of the winding to an N^{th} turn of the winding are contained in the second layer of the winding, and the N^{th} turn of the winding is for coupling with a switch.

16. The magnetic component according to claim 15, wherein the first layer of the winding and the second layer of the winding are located between the third layer of the winding and the fourth layer of the winding, the first layer of the winding is adjacent to the third layer of the winding, and the second layer of the winding is adjacent to the fourth layer of the winding.

17. The magnetic component according to claim 12, wherein layout-designed positions of the turns of the winding in the plurality of layers of the winding are biased toward a position of a turn of the winding having a lowest distribution voltage difference between the plurality of layers of the winding.

18. The magnetic component according to claim 17, wherein the layout-designed positions of the turns of the winding in the first layer of the winding are biased toward a position of a turn of the winding having a highest distribution voltage in the first layer of the winding.

19. The magnetic component according to claim 17, wherein the layout-designed positions of the turns of the winding in the second layer of the winding are biased toward a position of a turn of the winding having a lowest distribution voltage in the second layer of the winding.

20. The magnetic component according to claim 17, wherein the layout-designed positions of the turns of the winding in the first layer of the winding are biased toward a position of a turn of the winding having a highest distribution voltage in the first layer of the winding, and the layout-designed positions of the turns of the winding in the second layer of the winding are biased toward a position of a turn of the winding having a lowest distribution voltage in the second layer of the winding.

21. The magnetic component according to claim 15, wherein the magnetic component further comprises:
at least one secondary winding, disposed at a secondary side of the magnetic component,
wherein the at least one winding is disposed at a primary side of the magnetic component, and the third layer of the winding and the fourth layer of the winding respectively serve as shielding layers between the winding and the secondary winding.

22. A power supply, comprising the winding unit according to claim 1.
